(19) United States
(12) Patent Application Publication
(10) Pub. No.: US 2007/0174157 A1
(43) Pub. Date: Jul. 26, 2007

(54) SYSTEM AND METHOD FOR GENERATING SUPPLIERS GUARANTEE DEPOSITS

(75) Inventors: Hsueh-Tsung Lu, Shenzhen (CN); Kuan-Hong Hsieh, Shenzhen (CN); De-Qiang He, Shenzhen (CN); Li Liu, Shenzhen (CN); Sheng-Peng Tseng, Shenzhen (CN)

Correspondence Address: NORTH AMERICA INTELLECTUAL PROPERTY CORPORATION, P.O. BOX 506, MERRIFIELD, VA, 22116, US

(73) Assignee: HON HAI PRECISION INDUSTRY CO., LTD., Taipei Hsien (TW)

(21) Appl. No.: 11/616,291

(22) Filed: Dec. 27, 2006

(30) Foreign Application Priority Data
Jan. 10, 2006 (CN) 200610032903.3

(51) Int. Cl. G07F 19/00

(52) U.S. Cl. 705/30

(57) ABSTRACT

A method is provided for calculating an amount of guarantee deposit of a supplier, comprising: providing a server, in which stores a standard guarantee deposit rate table, a defect rate table, a standard defect rate table, a materials table recording a quantity and a unit price of each type of materials; obtaining a standard guarantee deposit rate from the standard rate table; determining a coefficient of the guarantee deposit by obtaining a defect rate and the standard defect rate of the materials respectively from the defect rate table and the standard defect rate table; determining an actual guarantee deposit rate of the materials according to the standard guarantee deposit rate and the coefficient; and calculating an amount of guarantee deposit according to the actual guarantee deposit rate and a quantity and a unit price of the materials obtained from the materials table.

### BACKGROUND OF THE INVENTION

1. Field of the Invention

The present invention relates to a system and method for generating amounts of guarantee deposits of suppliers to promote the suppliers to improve qualities of materials supplied.

2. Description of Related Art

Supplier management acts as an important role in enterprise management. Perfect and effective supplier management can promote a development of an enterprise. Qualities of materials supplied by supplies effect directly on a quality of products made from the materials. Thus, evaluating the qualities of the materials is a basic task for an enterprise to ensure the quality of the products.

A traditional way of evaluating a supplier is to use a scoring method. The supplier is given a score according to the qualities and prices of the materials he provides. The qualities of the materials is evaluated generally relying on a quality state and quality feedbacks of the materials, of which the quality state is reflected by a defect rate, a eligible rate, and/or other factors of the materials, and the quality feedbacks are associated with the supplier's countermeasures to decrease the defect rate of the materials.

Although the scoring method can promote the supplier to improve the qualities of the materials supplied, the risk rising from the defect rate of the materials supplied can only be assumed by the purchaser), and cannot promote the suppliers to further improve the quality of the supplied material.

What is needed is a system and method of generating a guarantee deposit of a supplier to further promote the supplier to improve qualities of materials supplied.

### SUMMARY OF THE INVENTION

A system for generating amounts of guaranty deposits of suppliers is provided. A preferred embodiment of the system comprises a plurality of purchaser terminal, a plurality of supplier terminals, and a server, each purchaser terminal and supplier terminal being connected to the server through network connection, the server stores a standard guarantee deposit rate table, a defect rate table, a standard defect rate table, a materials table recording a quantity and a unit price of each type of materials, and the server comprises a standard rate determining module, a coefficient determining module, an actual rate determining module, and a guarantee deposit calculating module. The standard rate determining module is for obtaining a standard guarantee deposit rate of a material from the standard guarantee deposit rate table. The coefficient determining module is for determining a coefficient of the guarantee deposit by obtaining a defect rate and a standard rate of the material respectively from the defect rate table and the standard defect rate table. The actual rate determining module is for determining an actual guaranty deposit rate of the materials according to the standard rate and the coefficient of the guarantee deposit. The guarantee deposit calculating module for calculating an amount of guarantee deposit according to the actual guarantee deposit rate and a quantity and a unit price of the material obtained from the materials table.

A method for generating an amount of guarantee deposit of a supplier is provided. A preferred embodiment of the method comprises: providing a server, in which stores a standard guarantee deposit rate table, a defect rate table, a standard defect rate table, a materials table recording a quantity and a unit price of each type of materials; obtaining a standard guarantee deposit rate from the standard rate table; determining a coefficient of the guarantee deposit by obtaining a defect rate and the standard defect rate of the material respectively from the defect rate table and the standard defect rate table; determining an actual guarantee deposit rate of the material according to the standard guarantee deposit rate and the coefficient; and calculating an amount of guarantee deposit according to the actual guarantee deposit rate and a quantity and a unit price of the materials obtained from the materials table.

Other advantages and novel features will be drawn from the following detailed description of the preferred embodiment with reference to the attached drawings, in which:

### BRIEF DESCRIPTION OF THE DRAWINGS

FIG. 1 is a hardware infrastructure diagram of a preferred embodiment of a system of generating amounts of guarantee deposits of suppliers;

FIG. 2 is a module diagram of a server of FIG. 1; and

FIG. 3 is a flow chart of a method of calculating a guarantee deposit of a material.

### DETAILED DESCRIPTION OF THE INVENTION

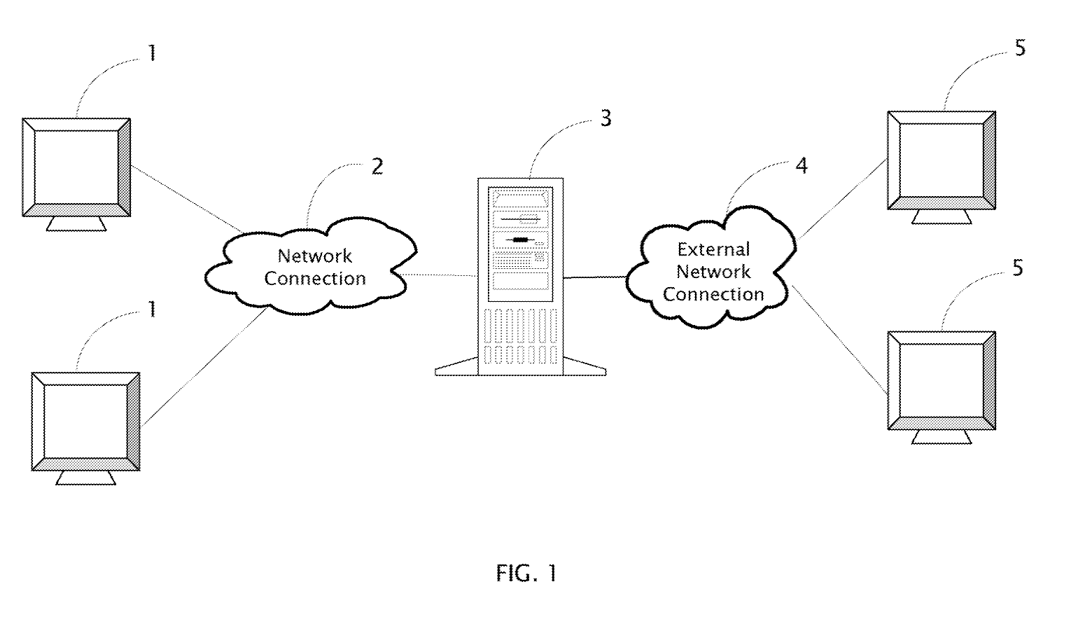

FIG. 1 is a hardware infrastructure diagram of a preferred embodiment of a system of suppliers guarantee deposits. The system of generating amounts of guarantee deposits of suppliers (hereafter “the system”) includes a plurality of purchaser terminals 1, a server 3, and a plurality of supplier terminals 5.

The purchaser terminals 1 are connected to the server 3 through a network connection 2 and the supplier terminals 5 are connected to the server 3 through an external network connection 4. The network connection 2 can either be an internal or an external connection, or a combination of the internal and external connections. The purchaser terminals 1 provide operation platforms for purchasers to obtain relative data from the server 3 and to command the server 3 to process the data such as calculating amounts guarantee deposits of suppliers. Commonly, the guarantee deposits are that the suppliers should pay to the purchasers to share the risk of rising defect rate of the materials the suppliers supply.

The server 3 is for receiving commands from the purchaser terminals and supplier terminals and for performing data processing according to the commands. The commands include calculating the suppliers guarantee deposits, searching and displaying the previous suppliers guarantee deposits. The server 3 stores a materials table, a defect rate table, a standard defect rate table, a standard guarantee deposit rate table, and a guarantee deposit statistics table.

The materials table stores materials information that includes a name, a quantity, and a unit price of each type of the materials that the purchaser may purchase. The defect rate table records defect statistics of a predetermined time range of each and every type of the materials. According to the preferred embodiment, the predetermined time range is configurable to be, for example, a year, a half year, a month, and any other time lengths. The average defect rate table records average defect percentages of the materials. The standard guarantee deposit rate table records standard guarantee deposit rates of the materials. The standard guarantee deposit rates are predetermined by the purchaser for providing standards for suppliers when the suppliers pay guarantee deposits to the purchasers. The guarantee deposit statistics table records a schedule and the amount of the guarantee deposit that the suppliers leaves/gives the purchaser.

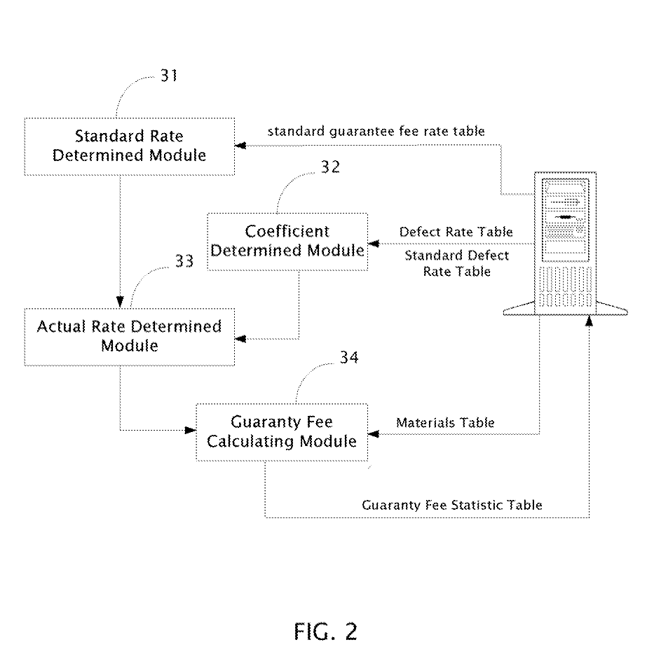

FIG. 2 is a module diagram of the server 3 of FIG. 1. The server 3 includes a standard guarantee deposit rate determining module 31, a coefficient determining module 32, an actual guarantee deposit rate determining module 33, and a guarantee deposit calculating module 34.

The standard guarantee deposit rate determining module 31 is for obtaining a standard guarantee deposit rate S of a materials from the standard guarantee deposit rate table. The coefficient determining module 32 is for obtaining a defect rate B of the last period of the materials and a standard defect rate A of the materials respectively from the defect rate table and the standard defect rate table, and calculating a coefficient C according to a formula: C=B/A.

The actual guarantee deposit rate determining module 33 is for determining an actual guarantee deposit rate P according to a formula: P=C*S.

The guarantee deposit calculating module 34 is for calculating an amount of guarantee deposit M of a supplier that supplies the material. The amount of guarantee deposit M is the supplier should pay to the purchaser this period. In this embodiment, the amount of guarantee deposit M is calculated according to a formula: M=Q*Pr*P, of which Pr is a unit price and the Q is the quantity of the material obtained from the materials table. The calculating result M is then recorded in the guarantee deposit statistic table.

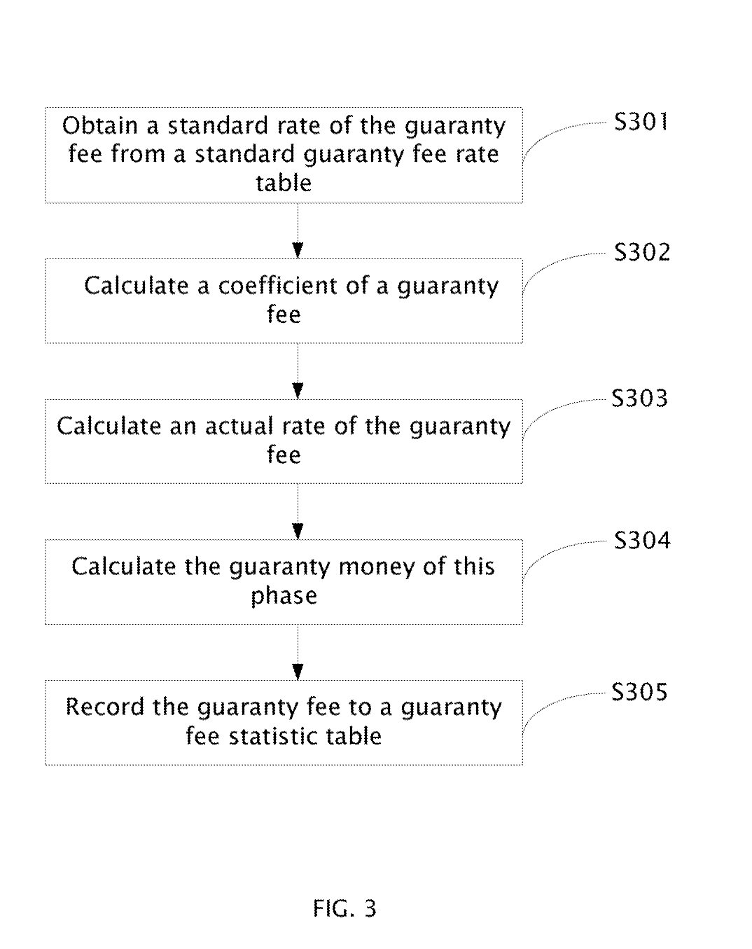

FIG. 3 is a flow chart of a method of calculating a guarantee deposit of a material.

In step S301, the standard guarantee deposit rate determining module 31 obtains the standard guarantee deposit rate S of the materials from the standard rate table.

In step S302, the coefficient determining module 32 obtains a defect rate B of a last period and the standard defect rate A of the materials respectively from the defect rate table and the standard defect rate table, and calculates a coefficient of the guarantee deposit according to the formula: C=B/A.

In step S303, the actual guarantee deposit rate determining module 33 calculates the actual guarantee deposit rate P of this period according to the formula: P=C*S.

In step S304, the guarantee deposit calculating module calculates the amount of guarantee deposit M of this period according to the formula: M=Q*Pr*P, of which Pr is the unit price and Q is quantity of the materials.

In step S305, the server 3 records the calculating result M in the guarantee deposit statistic table. After the guarantee deposit M is recorded in the guarantee deposit statistic table, the supplier that supplies the materials can access the server 3 and get know the amount of guarantee deposit he must pay to the purchaser this period.

According to the embodiment, the amount of a guarantee deposit that a supplier must pay is proportional to the corresponding actual guarantee deposit rate P, and the corresponding actual guarantee deposit rate P associates with the defect rate B of the materials the supplier supplies. When the defect rate B increases, the amount of the guarantee deposit also increases proportionally to the defect rate B. The supplier shares the risk rising from the increased defect rate of the material. Thus, to avoid the risk, the supplier must try to improve the quality of the material.

Although the present invention has been specifically described on the basis of a preferred embodiment, the invention is not to be construed as being limited thereto. Various changes or modifications may be made to the embodiment without departing from the scope and spirit of the invention.

What is claimed is:

1. A system for generating amounts of guaranty deposits of suppliers, comprising a plurality of purchaser terminals, a plurality of supplier terminals, and a server, each purchaser terminal and supplier terminal being connected to the server through network connection,
wherein:
the server stores a standard guarantee deposit rate table, a defect rate table, a standard defect rate table, a materials table recording a quantity and a unit price of each type of materials, and the server comprises:
a standard rate determining module for obtaining a standard guarantee deposit rate of a materials from the standard guarantee deposit rate table;
a coefficient determining module for determining a coefficient of the guarantee deposit by obtaining a defect rate and a standard defect rate of the materials respectively from the defect rate table and the standard defect rate table;
an actual rate determining module for determining an actual guaranty deposit rate of the materials according to the standard rate and the coefficient of the guarantee deposit;
a guarantee deposit calculating module for calculating an amount of guarantee deposit according to the actual guarantee deposit rate and a quantity and a unit price of the materials obtained from the materials table.

2. The system as described in claim 1, wherein the server further stores a guarantee deposit statistic table for storing a calculating result of the guarantee deposit.

3. The system as described in claim 1, wherein the coefficient is determined according to a formula: C=B/A, of which C represents the coefficient of the guarantee deposit, A represents the standard defect rate, and B represents the defect rate of the material.

4. The system as described in claim 1, wherein the actual guaranty deposit rate is determined according to a formula: P=C*S, of which P represents the actual guaranty deposit rate, C represents the coefficient of the guarantee deposit, S represents the standard guaranty deposit rate of the materials.

5. The system as described in claim 1, wherein the amount of guarantee deposit is calculated according to a formula: M=Q*Pr*P, of which M represents the amount of guarantee deposit the suppliers pay to the purchasers, Q represents the quantity of the materials, Pr represents the unit price of the materials, P represents the actual guaranty deposit rate.

6. A method for calculating an amount of guarantee deposit of a supplier, comprising:
providing a server which stores a standard guarantee deposit rate table, a defect rate table, a standard defect rate table, a materials table recording a quantity and a unit price of each type of materials;
obtaining a standard guarantee deposit rate from the standard rate table;
determining a coefficient of the guarantee deposit by obtaining a defect rate and the standard defect rate of the materials respectively from the defect rate table and the standard defect rate table;
determining an actual guarantee deposit rate of the materials according to the standard guarantee deposit rate and the coefficient; and
calculating an amount of guarantee deposit according to the actual guarantee deposit rate and a quantity and a unit price of the materials obtained from the materials table.

7. The method as described in claim 6, further comprising the step of storing a calculating result of the amount of guarantee deposit in the server.

8. The method as described in claim 7, wherein the coefficient is determined according to a formula: C=B/A, of which C represents the coefficient of the guarantee deposit, A represents the standard defect rate, and B represents the defect rate of the material.

9. The method as described in claim 7, wherein the actual guaranty deposit rate is determined according to a formula: P=C*S, of which P represents the actual guaranty deposit rate, C represents the coefficient of the guarantee deposit, S represents the standard guaranty deposit rate of the materials.

10. The method as described in claim 7, wherein the amount of guarantee deposit is calculated according to a formula: M=Q*Pr*P, of which M represents the amount of guarantee deposit the suppliers pay to the purchasers, Q represents the quantity of the materials, Pr represents the unit price of the materials, P represents the actual guaranty deposit rate.
